(19) United States
(12) Patent Application Publication
(10) Pub. No.: US 2007/0281872 A1
(43) Pub. Date: Dec. 6, 2007

(54) Slide Bearing Material

(76) Inventors: Werner Schubert, Wiesloch (DE); Wolfgang Bickle, Reilingen (DE); Adam Strifler, St. Leon-Rot (DE)

Correspondence Address: DREISS, FUHLENDORF, STEIMLE & BECKER, POSTFACH 10 37 62, D-70032 STUTTGART, DE

(21) Appl. No.: 10/589,567

(22) PCT Filed: Feb. 21, 2005
(86) PCT No.: PCT/EP05/01766

§ 371 Date: Jun. 18, 2007

(51) Int. Cl. F16C 33/12

(52) U.S. Cl. 508/103; 384/29

(57) ABSTRACT

The invention relates to a slide bearing material comprising a metallic supporting layer and a metallic lead-free bearing layer consisting of densely sintered powder particles of tin bronze with bismuth additives. The aim of the invention is to create a lead-free slide bearing material with nevertheless good tribological properties and a high bearing capacity. To this end, the bearing metallic layer is formed from a sintering powder consisting of powder particles containing between 9.5 and 11 wt. % of tin and between 7 and 13 wt. % of bismuth and copper. The powder particles have a nobular form deviating from the regular spherical form but without edges and undercuts.

The invention concerns a slide bearing material with a metallic support layer and a metallic, lead-free bearing metal layer of densely sintered powder particles of tin bronze with bismuth additives.

Slide bearing materials and slide bearings produced therefrom are well known. Bearing metal layers of lead-containing tin bronze, e.g. CuSn10Pb10 have been conventionally used. However, the demand for lead-free bearing materials continues to increase.

WO 03/031102 A1 discloses e.g. a lead-free slide bearing material, wherein an initially porous sintered layer is completely compressed to form the sliding layer. The sliding layer material comprises 8 to 12 weight % of tin, 1 to less than 5 weight % of bismuth, 0.03 to 0.08 weight % of phosphorous, the rest being copper, and is therefore of the present type. According to the teaching of this document, the layer is produced from a mixture of different particles having different compositions, such that the portion of bismuth in the completely compressed state of the sliding layer does not exceed 5 weight % to avoid weakening of the matrix structure of the sliding layer material.

EP 0 687 740 B1 discloses a lead-free bearing metal which is cast as a monometal to form sliding elements. The main components of the lead-free composition are 4.85 to 9 weight % of tin and 3.81 to 9 weight % of bismuth, the rest being copper.

EP 0 224 619 B1 discloses a number of partially lead-free bearing metal alloys comprising between 0.5 and 4 weight % of tin, 10 to 20 weight % of bismuth and 0 to 1 weight % of lead etc., the rest being copper. The bearing alloy can be disposed onto a steel support layer through sintering, casting or rolling.

It is the underlying purpose of the present invention to provide a lead-free slide bearing material of the above-mentioned type, which nevertheless has good tribological properties and a high load capacity and is suited for high speeds such as e.g. for connecting rod bearing applications or main bearing applications for engines.

This object is achieved in accordance with the invention with a slide bearing material of the above-mentioned type in that the bearing metal layer is formed from a sintering powder which consists of powder particles comprising 9.5 to 11 weight % of tin and 7 to 13 weight % of bismuth and copper, wherein the powder particles do not have a regular spherical shape rather a bulbous shape but without edges and undercuts.

In accordance with the invention, it has turned out that the high bismuth content provides the present slide bearing material with an excellent scoring resistance without reducing the load capacity thereof. The bismuth is present in the form of a separate phase, like lead, and has a temperature-stabilizing and also lubricating effect due to the likewise low melting point. It has turned out that the load capacity of the densely sintered bearing metal layer is not excessively negatively influenced by the high bismuth portion, when the powder particles of the sintering powder have a substantially bulbous, non-spherical shape and when all have the same alloy composition. This ensures a homogeneous structure of the densely sintered bearing metal layer with uniformly distributed bismuth, i.e. lubricant, precipitations. It has turned out that only the bismuth additive within the claimed range can produce a lead-free bulbous sintering powder. It has also surprisingly turned out that a bearing metal layer which is densely sintered from bulbous sintering powder particles yields load capacities and load resistances with very high bismuth contents which cannot be achieved with use of spherical sintering powder particles. The bulbous shape as claimed, which differs from the regular spherical shape, defines powder particles which are not spherical, but which have no edges and undercuts such as e.g. irregular, “spattered” powder particles which have solidified into bizarre structures. The bulbous shape is a round shape but has a diameter ratio or length/width ratio of approximately 1.5 to 3. Although the ideal spherical shape has a diameter ratio of 1, in practice, the majority of spherical powder particles are within a range of 1 to 1.1. A bulbous sintering powder of the present composition may react differently to initial porous sintering and subsequent compression than a very regular spherical sintering powder.

It has, however, also turned out that use of one single type of powder particles, i.e. only one composition, is essential to form the bearing metal layer, to obtain a maximum homogeneous solidity within the bearing metal layer which is essentially defined by the connecting regions between the powder particles.

The bulbous metallic powder particles which form the densely sintered bearing metal layer advantageously have a characteristic grain size of between 40 and 75, preferably between 40 to 65 μm. 50 mass % of the bulk has grain sizes which are greater than the characteristic grain size (in μm) and 50% which are less. It is therefore an average particle size. The grain size distribution for a certain bulk is determined through screening refuse examination. The result of screening refuse examinations can either be stated in mass % (not accumulated) for a respective mesh size or be accumulated according to DIN ISO 4497 (such that almost 100 mass % is determined for the smallest mesh size). The accumulated screening refuse can be given by a distribution function, i.e.

$$\begin{matrix} & - {( \frac{t}{η} )}^{β} \\ R = e & \end{matrix}$$

R=accumulated screening refuse
t=mesh size
η=characteristic grain size=
β=shape parameter (slope of the straight line with logarithmic plotting according to DIN 66 145).

A preferred grain size distribution is characterized by a shape parameter of 1.2 to 2.6 and a characteristic grain size in the above-stated range. Bulbous powder particles having a bulk density of 5.1 to 5.5 are preferably used to produce the carrier layer. The bulk density of a specific powder material (bulk) for filling a predetermined volume with bulk powder is that factor which, when multiplied by the mass of water which would fill the same volume, yields the mass of the powder. Filling a volume of 100 cm³ with bulk powder yields a powder mass of 510 to 550 g. This bulk density value depends on the geometry of the powder of a given alloy composition (and therefore on the given specific weight).

Preferred compositions of the powder particles can be extracted from the following claims. The alloy consists, in particular, of the alloy components stated in the claims, with optional impurity-related additives of an overall amount of less than 1 weight %.

A preferred alloy composition for the production of the powder particles which are used to form the densely sintered bearing metal layer is a CuSn10Bi8 alloy.

1-7. (canceled)

8. A slide bearing material, comprising:
a metallic support layer; and
a lead-free bearing layer comprising densely sintered metallic powder particles, said powder particles consisting essentially of 9.5 to 11 weight % of tin, 7 to 13 weight % of bismuth, 0 to 4.0 weight % of zinc, the rest copper, and impurities of an overall amount of less than 1 weight %, wherein the powder particles have a bulbous shape, differing from a regular spherical shape, but without edges and undercuts.

9. The slide bearing composite material of claim 8, wherein a grain size distribution of said metallic particles has a characteristic grain size of 40 to 75 μm or of 40 to 60 μm.

10. The slide bearing composite material of claim 8, wherein a grain size distribution of said metallic particles is characterized by a shape parameter β of 1.2 to 2.6.

11. The slide bearing material of claim 8, wherein said powder particles comprise 7 to 11 weight % of bismuth.

12. The slide bearing material of claim 11, wherein said powder particles comprise 7.5 to 10 weight % of bismuth.

13. The slide bearing material of claim 8, wherein said powder particles comprise 9.5 to 10.5 weight % of tin.

14. A slide bearing bushing or shell, a connecting rod bearing bushing, a connecting rod bearing shell, or a main bearing shell, produced from the slide bearing composite material of claim 8.
